(19) United States
(12) Patent Application Publication
(10) Pub. No.: US 2014/0246705 A1
(43) Pub. Date: Sep. 4, 2014

(54) Programmable Leakage Test For Interconnects In Stacked Designs

(71) Applicant: Mentor Graphics Corporation, Wilsonville, OR (US)

(72) Inventors: Shi-Yu Huang, Taoyuan (TW); Kun-Han Tsai, Lake Oswego, OR (US); Wu-Tung Cheng, Lake Oswego, OR (US); Yu-Hsiang Lin, Taipei (TW); Li-Ren Huang, Taipei (TW)

(73) Assignee: Mentor Graphics Corporation, Wilsonville, OR (US)

(21) Appl. No.: 14/195,639

(22) Filed: Mar. 3, 2014

Related U.S. Application Data
(60) Provisional application No. 61/771,767, filed on Mar. 1, 2013.

(51) Int. Cl. G06F 17/50

(52) U.S. Cl. CPC G06F 17/5081
USPC 257/209; 716/136

(57) ABSTRACT

Aspects of the invention relate to techniques of testing interconnects in stacked designs for leakage defects. Logic “1” or “0” is first applied to one end of an interconnect during a first pulse. Then, logic value at the one end is captured, which triggered by an edge of a second pulse. The first pulse precedes the second pulse by a time period being selected from a plurality of delay periods. The plurality of delay periods is generated by a device shared by a plurality of interconnects.

### RELATED APPLICATIONS

This application claims priority to U.S. Provisional Patent Application No. 61/771,767, filed on Mar. 1, 2013, and naming Shi-Yu Huang et al. as inventors, which application is incorporated entirely herein by reference.

### FIELD OF THE INVENTION

The present invention relates to the field of integrated circuit (IC) testing technology. Various implementations of the invention may be particularly useful for testing and characterizing interconnects of stacked integrated circuits.

### BACKGROUND OF THE INVENTION

Expanding into the third dimension enables chip manufacturers to continue shrinking transistors to boost speed without adding power leaks. However, chip stacking is limited by wiring-related problems. Today's interconnects do not run through the silicon itself but go millimeters around it, impeding speedy signaling and increasing power consumption along the way. 2-D (horizontal) real estate is also valuable. Even the thinnest interconnects must still be packed along the edges of a chip, imposing strict limits on how many input/output connections the chip can handle. Consequently, going vertical (3-D) by connecting one chip to another with lines that go straight through the silicon—commonly known as through-silicon vias (TSVs)—offers the numerous potential benefits. In particular, more connections can be packed side by side using much slimmer wires. Going through chips instead of around the side also reduces the length of interconnects from millimeters to microns or even less—as thin as individual wafers can be produced. It has been estimated that the switch to vertical interconnects may reduce power consumption in half, increase bandwidth by a factor of eight, and shrink memory stacks by some 35 percent.

As several hundreds of thousands of TSVs in a single package provide power/ground, clock, functional signals, as well as test access to logic blocks of different layers of the device, they become not only the key components of 3-D ICs but also make up a crucial test infrastructure. In order to form TSVs, one has to etch deep, narrow holes into a silicon wafer and then fill them with a nearly flawless layer of insulating material and then copper. But as a wafer heats up, copper expands at more than five times the rate that silicon does, exerting stress that can crack the wafer and render it useless. Because of such imperfect etching, ragged wafer surface, and potential wafer misalignments, certain TSVs in one wafer after thinning and polishing might not be completely exposed or aligned with their counterparts on the other wafer. Since the bonding quality of TSVs depends on the winding level of the thinned wafer as well as the surface roughness and cleanness of silicon dies, defective TSVs tend to occur in clusters, though even a single TSV defect between any two layers can void the entire chip stack, reducing the overall yield.

These mechanisms can lead to not only catastrophic defects but also parametric defects. There are two major parametric defects occurring at TSVs, resistive open defects and leakage defects. A resistive open defect occurs when a TSV has excessive resistance, which could result in extra delay across the TSV. Conventional at-speed test may detect it using transition fault test patterns when a large delay exists. However, for more elusive small delay, conventional at-speed test is unavailable. A leakage defect occurs when the conducting material of a TSV mistakenly penetrates the insulator between a TSV and its surrounding substrate. Such a defect causes leakage during the time when the TSV is being charged up to a high voltage. It could degrade the performance of the TSV and sometimes pose a reliability threat as the defect worsens over time. In the literature, it has also been called open-sleeve fault (defect), or short fault (defect).

A leakage test threshold is often used for testing leakage defects. Traditionally, an I/O (Input/Output) pin has a leakage defect if it has a leakage current above 1 μA. Most previous TSV test methods have employed leakage test thresholds in the range of 10-100 μA. Different methods cover different ranges of leakage test thresholds, and multiple methods may need to be combined to cover a wide range that satisfies different system-level requirements.

In general, there are two major types of methods for leakage test. The first type is referred to as L2VCC (Leakage to Voltage Conversion and then Comparison). FIG. 1 illustrates a L2VCC method. In a test mode, a pull-up device 110 is used to establish a voltage at an end (observation node 120) of a TSV 130. The pull-up device 110 could be a resistor, or a turned-on transistor. Along the leakage path to ground (indicated as Rleak 140), a voltage divider will be formed. After the circuit is stabilized, the voltage level of the observation node 120 reflects the amount of leakage. A voltage comparator 150 may be used to indicate whether the TSV is defective.

The L2VCC method has some major drawbacks. First, the method is not very easy to implement. Analog or custom circuitry might be required to perform analog voltage detection. Also, transmitting an analog reference voltage to each TSV, as needed, could be a daunting task. Second, the method usually targets leakage current in the range from 10 μA to 100 μA, and may not be very suitable for the detection of small leakage (e.g., less than 1 μA), because in that case the equivalent leakage resistance would be about 100 kΩ, assuming VDD=1 V and 2 kΩ for the pull-up device 110 and resulting stable voltage at the observation node 120 would be about 0.98 V. Detection whether a voltage is greater than this value with VDD=1 V is too challenging.

The second type of methods for leakage test is referred to as CAF-WAS (Chareg-up-and-Float, wait-and-Sample). FIG. 2 illustrates a CAF-WAS method. In the figure, the Input/Output pin-under-test 210 is driven by a tri-state buffer 220, and is also connected to the input of an output buffer 230. The test operation is performed in three steps: (1) turning on the tri-state buffer to charge up the I/O pin 210 to VDD by applying a logic “1” to the control as well as the input of the tri-state buffer 220; (2) turning off the tri-state buffer 220 to float the I/O pin 210 and wait for certain time (e.g., 3 μs) to allow the leakage current to take effect; and (3) sampling the value at the output of the output buffer 230 and perform pass/fail detection based on the binary result.

The voltage at the I/O pin 210 would dropped below VDD/2 at the end of the waiting period if the leakage current is larger than 1 μA. Accordingly, the sampled value at the output of the output buffer 230 would be a logic “0”, indicating the presence of a leakage fault. Otherwise, a logic “1” would be sampled, indicating a passing condition. The above procedure can be modified slightly to test if there is an unwanted conducting path to VDD at the I/O pin 210 by changing the charge value from “1” to “0”, and interpreting the sampled value inversely (i.e., “0” for passing and “1” for failing).

This CAF-WAS method is elegant in that it uses only low-cost logic gates and its ability to detect very tiny leakage current (˜1 μA). However, two issues may prevent it from being applicable to the TSV leakage test directly. First, the capacitance of a TSV could be 100 times smaller than an I/O pin (e.g., 40 fF of a 5 μm-diameter TSV versus 3 pF IO pin). As to be analyzed in detail later, this CAF-WAS method uses 2˜3 test clock cycles as the waiting time period and may not be good for handling small capacitance. Second, the leakage test threshold may vary. If the leakage test threshold for a TSV is set to be 10 μA instead of 1 μA in another 3D circuit, then the CAF-WAS method needs to be modified to be flexible enough to accommodate the new leakage test threshold.

### BRIEF SUMMARY OF THE INVENTION

Various aspects of the present invention relate to techniques of testing interconnects in stacked designs for leakage defects.

In one aspect, there is a method, comprising: applying logic “1” or “0” to one end of an interconnect during a first pulse; and capturing, triggered by an edge of a second pulse, logic value at the one end, the first pulse preceding the second pulse by a time period, the time period being selected from a plurality of delay periods, the plurality of delay periods being generated by a logic device shared by a plurality of interconnects.

The interconnect may be a through-silicon via (TSV) or an interposer. A tri-state buffer may be used for the applying operation. A flip-flop may be used for the capturing operation.

The first pulse and the second pulse may be derived from two consecutive pulses of a signal. The first pulse may be generated by a flip flop and a gating device based on an early pulse of the two consecutive pulses and the second pulse may directly use a late pulse of the two consecutive pulses.

In another aspect, there is an integrated circuit, comprising: a first device configurable to apply logic “1” or “0” to one end of an interconnect during a first pulse; a second device configurable to capture, triggered by an edge of a second pulse, logic value at the one end, the first pulse preceding the second pulse by a time period, the time period being selected from a plurality of delay periods; and a third device, shared by a plurality of interconnects, configurable to generate the plurality of delay periods.

The first device may be a tri-state buffer. The second device may be a flip-flop. The integrated circuit may further comprise a fourth device configurable to generate a signal comprising two pulses, an early pulse of the two pulses being used to generate the first pulse, a late pulse of the two pulses being used as the second pulse.

In still another aspect, there is one or more non-transitory processor-readable media storing processor-executable instructions for causing one or more processors to create test circuitry in a design of an integrated circuit, the test circuitry comprising: a first device configurable to apply logic “1” or “0” to one end of an interconnect during a first pulse; a second device configurable to capture, triggered by an edge of a second pulse, logic value at the one end, the first pulse preceding the second pulse by a time period, the time period being selected from a plurality of delay periods; and a third device, shared by a plurality of interconnects, configurable to generate the plurality of delay periods.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates an example of a L2VCC (Leakage to Voltage Conversion and then Comparison) method.

FIG. 2 illustrates an example of a CAF-WAS (Chareg-up-and-Float, wait-and-Sample) method.

FIG. 3A illustrates an example of test circuitry for leakage test that may be implemented according to various embodiments of the invention.

FIG. 3B illustrates waveforms of the LTE signal 350 and the LT_Pulse signal 380 in FIG. 3A.

FIG. 4A illustrates an example of a circuit for generating a plurality of delay periods that may be implemented according to various embodiments of the invention.

FIG. 4B illustrates waveforms of the signals in FIG. 4A.

FIG. 5A illustrates an example of a block diagram of the one-short circuit 450 in FIG. 4A.

FIG. 5B illustrates waveforms of the signals in FIG. 5A.

FIG. 6A illustrates an example of a block diagram for a test controller that generates the self-timed timing control signal

FIG. 6B illustrates an example of the self-timed wait-time generator 640 shown in FIG. 6A.

FIG. 6C illustrates waveforms of the signals for the test controller shown in FIG. 6A.

FIG. 7A illustrates an example of a test wrapper that employs the self-timed timing control signal.

FIG. 7B illustrates waveforms for the signals in FIG. 7A.

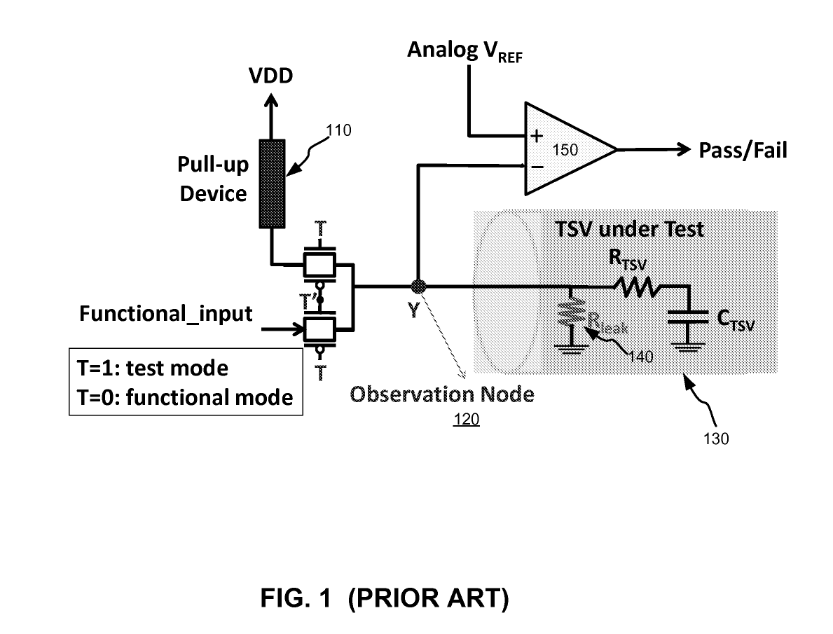

### DETAILED DESCRIPTION OF THE INVENTION

Various aspects of the present invention relate to techniques of testing interconnects in stacked designs for leakage defects. Two examples of interconnects are TSVs for three-dimensional designs and interposers for two-and-half-dimensional designs. In the following description, numerous details are set forth for the purpose of explanation. However, one of ordinary skill in the art will realize that the invention may be practiced without the use of these specific details. In other instances, well-known features have not been described in details to avoid obscuring the present invention.

Some of the techniques described herein can be implemented in software instructions stored on one or more non-transitory computer-readable media, software instructions executed on a processor, or some combination of both. As used herein, the term “non-transitory computer-readable medium” refers to computer-readable medium that are capable of storing data for future retrieval, and not propagating electro-magnetic waves. The non-transitory computer-readable medium may be, for example, a magnetic storage device, an optical storage device, a “punched” surface type device, or a solid state storage device. Some of the disclosed techniques, for example, can be implemented as part of an electronic design automation (EDA) tool. Such methods can be executed on a single computer or on networked computers.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one microdevice, such as data to be used to form multiple microdevices on a single wafer.

The present disclosure also includes some hardware drawings. These drawings are only illustrative and are non-limiting. For illustrative purposes, the size of some of the elements in the drawings may be exaggerated and not drawn on scale, and some elements in the drawings may be omitted.

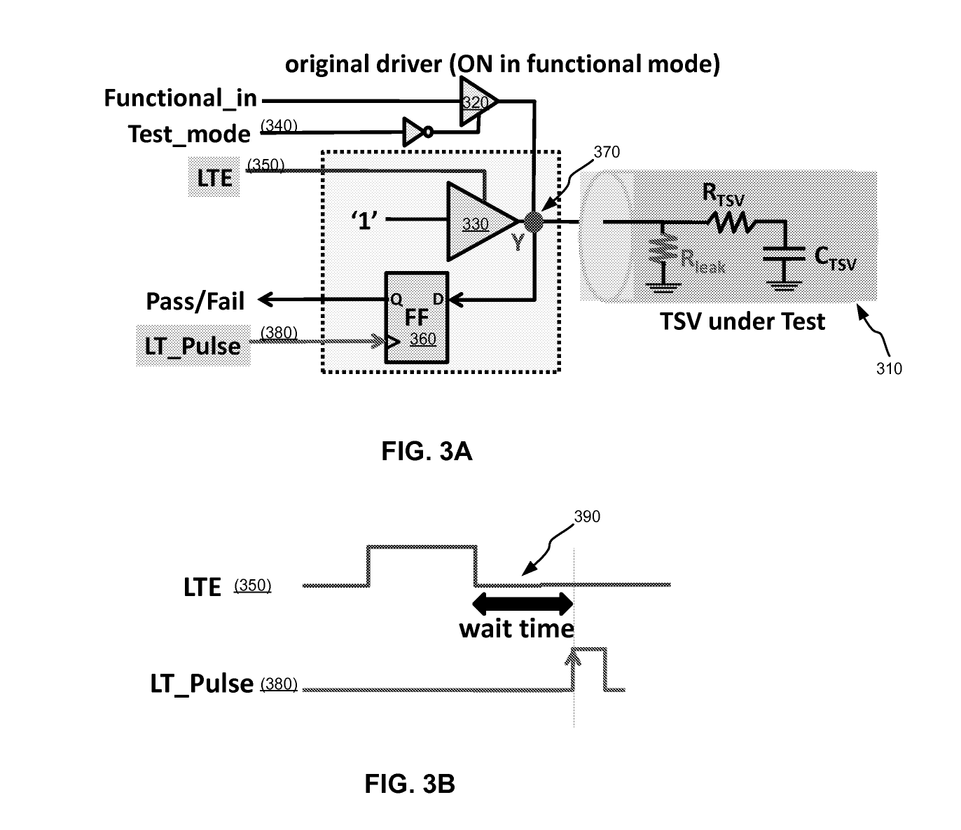

FIG. 3A illustrates an example of test circuitry for leakage test that may be implemented according to various embodiments of the invention. Two tri-state buffers are used for testing a TSV 310: a functional-mode tri-state buffer 320 and a test-mode tri-state buffer 330. The former is active only when the signal “Test_mode” (340) is “0” and the latter is active only when a signal called LTE (350) is “1”. In addition to the two tri-state buffers, a flip-flop 360 is configured to sample the voltage at node Y 370 at a proper time, producing the final pass/fail result. The sampling is controlled by a signal called “LT Pulse” (380).

FIG. 3B illustrates waveforms of the LTE signal 350 and the LT_Pulse signal 380. When the LTE signal 350 is “1”, the test-mode tri-state buffer 330 is turned on. During a leakage test cycle, the LTE signal 350 goes HIGH for a period of time sufficiently long enough for the node Y 370 to charge up to VDD before returning back to LOW to float the node Y 370.

After a time period called wait time (390), a pulse of the LT Pulse signal 380 arrives with its rising edge (positive edge) triggering the sampling operation. The logic value captured by the flip-flop 360 indicates the binary pass/fail test result: “1” means “Pass” whereas “0” means “Fail”.

The wait time 390 should be selected with care as it is closely related to the leakage test threshold. Assuming 1 V of V_{DD} and 40 fF of TSV capacitance (C_{TSV}), the wait time needed for a particular leakage test threshold value (LTT) can be approximated by the following formula:

Wait time=(C_{TSV}×0.5V_{DD})/LTT Eq. (1)

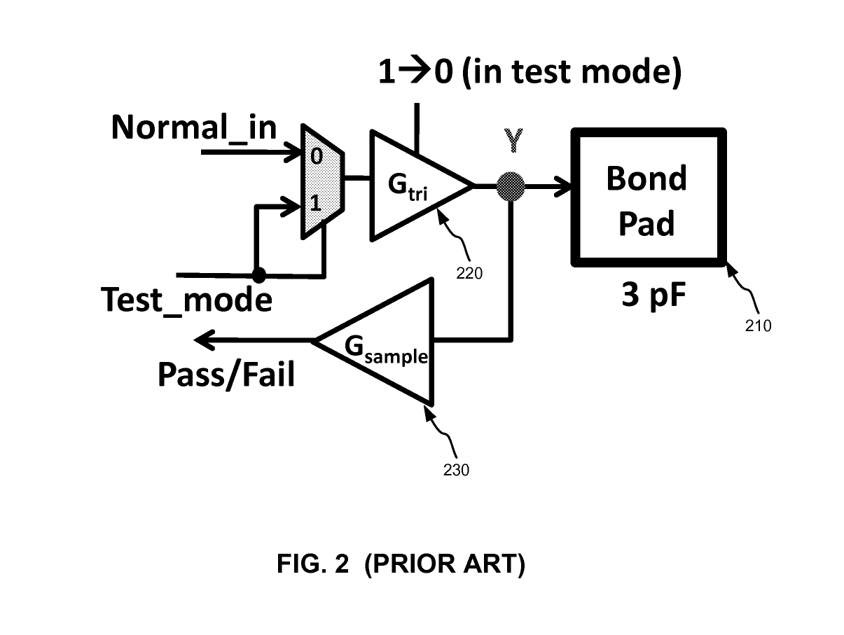

In principle, the wait time 390 is the time required for the node Y 370 to drop below 0.5V_{DD} from V_{DD} assuming that the leakage current is constant at the LTT value. If the LTT value is 10 μA as in the standard IO pin leakage test, the wait time will be about (40 fF×0.5V)/10 μA=2 ns. For a test running at 1 MHZ (or at a clock period of 1000 ns), this is only 1/500 of the clock cycle time, too small to be represented in multiples of the test clock cycle time used by the circuit (prior art) shown in FIG. 2.

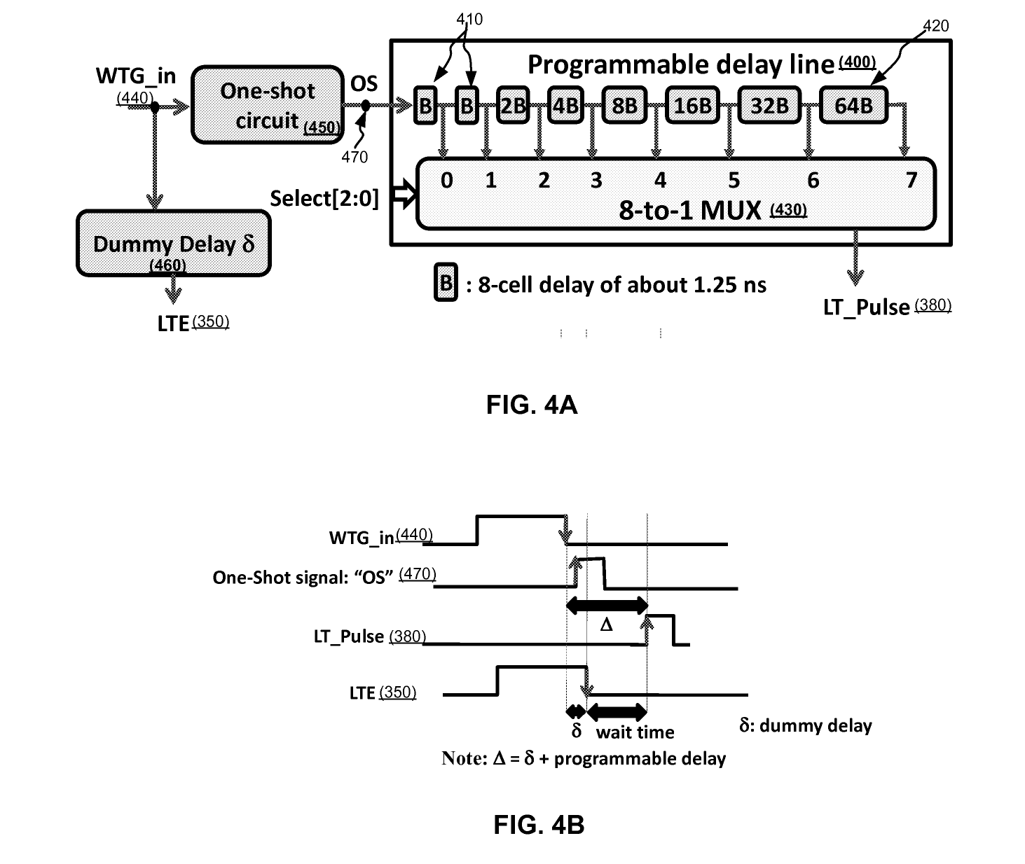

FIG. 4A illustrates an example of a circuit for generating a plurality of delay periods that may be implemented according to various embodiments of the invention. The circuit has a programmable delay line 400. The programmable delay line 400 comprises units with multiples of a cell delay (representing 0.156 ns). A B unit 410, comprising eight cells, represents a delay of 1.25 ns while a 64B unit 420, comprising 1024 cells, represents a delay of 80 ns. Accordingly, the programmable delay line 400 has eight possible delay outputs ranging from 1.25 ns to 160 ns. An 8-to-1 multiplexer 430 is used to select the wait time. The select input for the 8-to-1 multiplexer 430 has three bits. Table 1 lists the wait time lengths for different leakage test thresholds along with the select signal for the 8-to-1 multiplexer 430.

TABLE 1
Assuming V_{DD} = 1 V and C_{TSV} = 40 fF

| | | | |
|---|---|---|---|
| Leakage Test | Wait Time | No. of Buffer | |
| Threshold | (ns) | Delays | Select[2:0] |

| | | | | |
|---|---|---|---|---|
| 0.125 | μA | 160 | 1024 | ‘111’ |
| 0.25 | μA | 80 | 512 | ‘110’ |
| 0.5 | μA | 40 | 256 | ‘101’ |
| 1 | μA (typical) | 20 | 128 | ‘100’ |
| 2 | μA | 10 | 64 | ‘011’ |
| 4 | μA | 5 | 32 | ‘010’ |
| 8 | μA | 2.5 | 16 | ‘001’ |
| 16 | μA | 1.25 | 8 | ‘000’ |

In FIG. 4A, a signal called ‘WTG_in’ 440, a given pulse signal (similar to the test clock signal TCLK), is used to create the signal LTE 350 and the signal LT_Pulse 380. For the LT Pulse generating path (the programmable delay line 400+a one-shot circuit 450), the overall delay (from ‘WTG_in’ 440 to LT_Pulse 380), denoted as Δ, is:

Δ=δ+programmable delay Eq. (2)

where δ represents the delay by the one-shot circuit 450.

Ideally, the wait-time should be solely determined by the programmable delay line. To achieve this goal, the δ-part is unwanted and needs to be calibrated away. This can be achieved to some extent by adding a δ-delay element such as a dummy delay δ 460 to the other path (i.e., the path from ‘WTG_in’ to LTE).

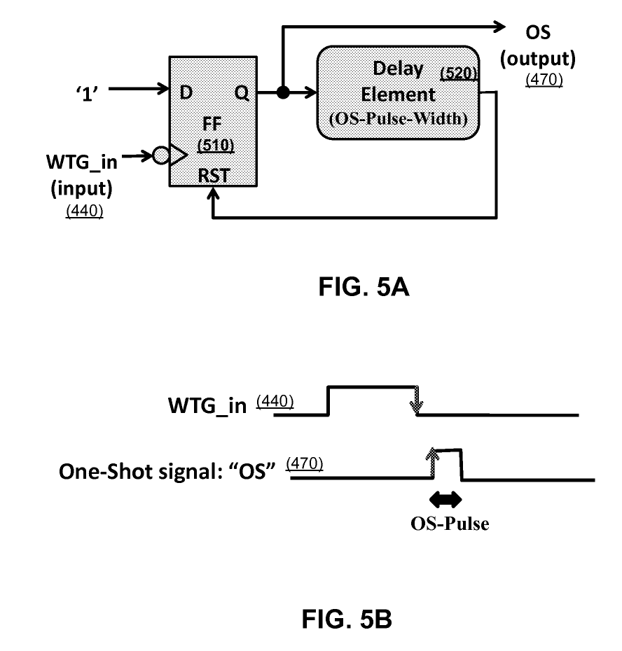

The one-shot circuit 450 is configured to generate a one-shot signal OS 470 and converts the pulse width of ‘WTG_in’ 440 to the desired pulse width of LT_Pulse 380. FIG. 5A illustrates an example of a one-short circuit 450. The input signal ‘WTG_in’ 440 drives a negative-edge triggered flip-flop 510. The flip-flop 510 charges up its output to HIGH when triggered. Then, after some time (realized by a delay element whose delay is denoted as OS-pulse-width), this HIGH-valued signal will loop back to reset the flip-flop 510 to ‘0’; which is now ready again for the next one-shot signal generation when the next negative edge of ‘WTG_in’ 440 arrives.

FIG. 4B illustrates waveforms of the signals in FIG. 4A and FIG. 5B waveforms of the signals in FIG. 5A.

The signals LTE 350 and LT_Pulse 380 may spend different amounts of time to arrive at a TSV because the physical routing paths may be different. This can affect the integrity of the wait time. In other words, it is very likely that a TSV may experience different wait time than the original one generated at the test controller. This problem can only become worse when there are many TSVs sharing the same LTE and LT_Pulse signals.

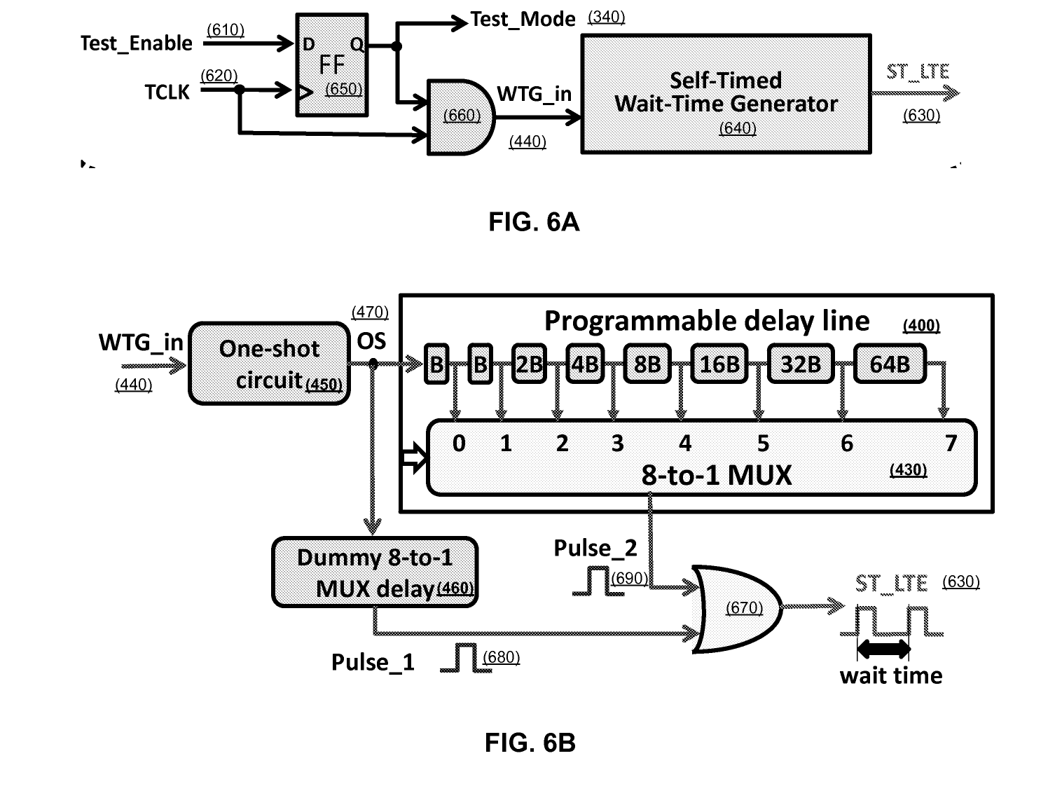

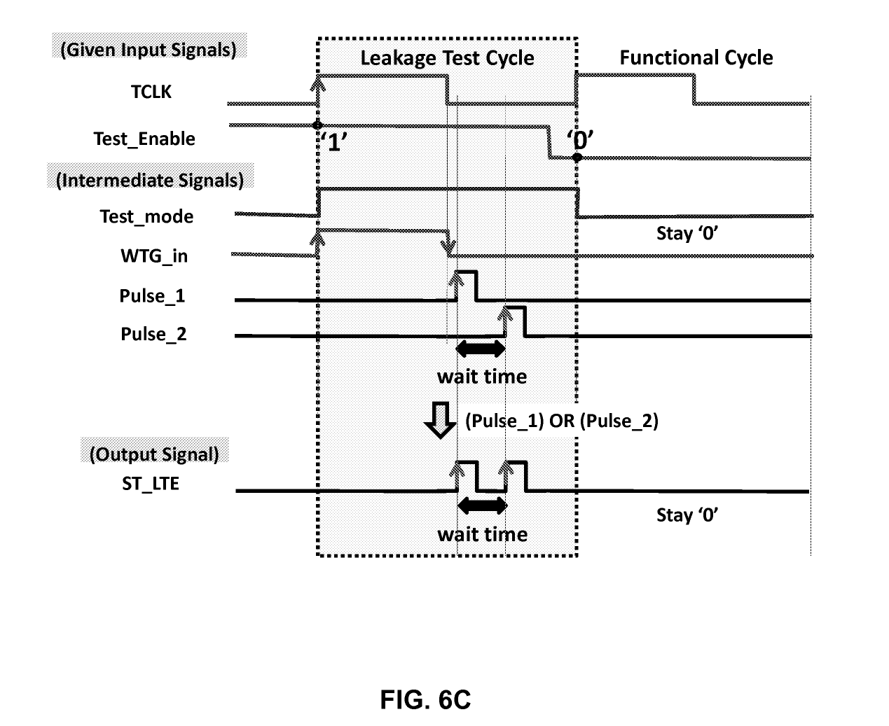

With some implementations of the invention, the same LTE and LT_Pulse signals are derived locally from two consecutive pulses of a signal. This signal is referred to as a self-timed timing control signal. FIG. 6A illustrates an example of a block diagram for a test controller that generates the self-timed timing control signal. The test controller comprises a self-timed wait-time generator 640, a flip flop 650 and an AND gate 660. The input signals of the test controller are a TCLK signal 620 and a Test_Enable signal 610. The former is the test clock signal at a specific test frequency (e.g., 1 MHz) and the latter is a signal that decides whether the test controller should activate a leakage test. If Test_Enable (610) is “1” at the rising edge of a test clock cycle, then an output signal, Test_mode (340), will be “1” throughout that test clock cycle and another output signal, the self-timed timing control signal (ST_LTE (630)), will go up and down to enable a leakage test cycle with proper wait-time information. Otherwise, Test_mode (340) and ST_LTE (630) will stay at ‘0’ throughout that test clock cycle and the TSVs will operate in their functional modes.

An internal signal, WTG in (440), is generated by a clock gating circuit from {TCLK (620) and Test_Enable (610)}. The clock gating circuit comprises a flip-flop 650 and an AND gate 660. Due to these two devices, when Test_Enable (610) is “1”, WTG_in (440) is a copy of TCLK (620) in those clock cycles and when Test_Enable (610) is “0”, WTG_in (440) remains “0”.

FIG. 6B illustrates an example of the self-timed wait-time generator 640 shown in FIG. 6A. The self-timed wait-time generator 640 is similar to the circuit shown in FIG. 4A. However, the signal LTE 350 and the signal LT Pulse 380 in FIG. 4A become two internal signals: Pulse_1 (680) and Pulse_2 (690). These two internal signal are combined by an OR gate 670 to produce the two-pulse signal ST_LTE (630). In addition, the dummy delay is now equal the 8-to-1 MUX delay 460 since the delay between signals Pulse_1 and Pulse_2 are determined purely by the programmable delay line, not by propagation paths to TSVs.

FIG. 6C illustrates waveforms of the signals for the test controller shown in FIG. 6A. Compared to the waveforms shown in FIG. 4B, the wait time is now represented by the time interval between the two rising edges, rather than that between one falling edge and one rising edge. Using the same type of edges may help reduce the pulse-width distortion. This is mainly because the pulse width of a signal tends to either expand or shrink slightly when passing through a buffer, due to the discrepancy the rise time and the fall time. Such a distortion could accumulate to a significant amount if the signal is to pass through a large number of identical cascaded buffers. An analogy can be drawn from a clock routing network - where the pulse width of a clock signal could change from one circuit node to another throughout the routing network, while the clock period (like our wait time) defined from one rising edge to the next typically remains invariant.

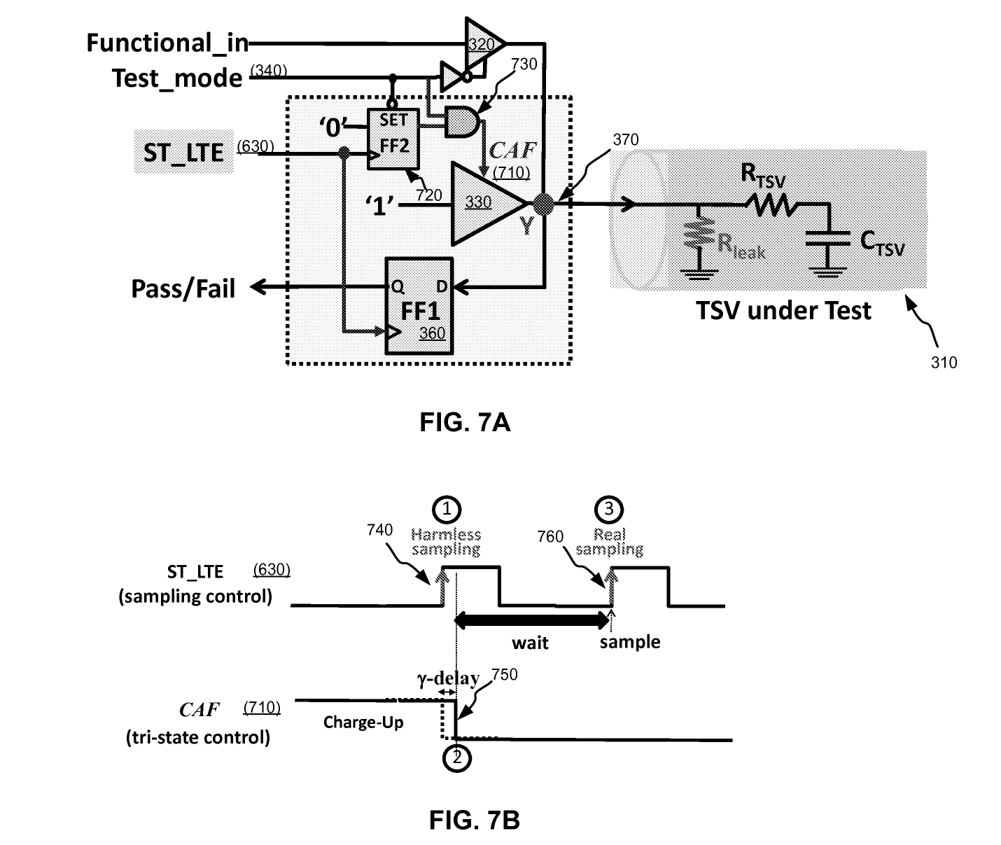

FIG. 7A illustrates an example of a test wrapper that employs the self-timed timing control signal. Compared to the circuitry shown in FIG. 3A, there are two additional devices: a second flip-flop 720 and an AND gate 730. The flip-flop 720 receives signal ST_LTE 630 at its clock port. Its Q-pin output signal is further gated with signal Test_mode 340 through the AND gate 730. The output of the AND gate 730, denoted as signal CAF 710 (Charge-and-Float), is used to generate the control signal of the tri-state buffer (the signal LTE 350 in FIG. 3A). The signal ST_LTE 630 is also directly coupled to the clock port of the sampling flip-flop 360.

FIG. 7B illustrates waveforms for the signals in FIG. 7A. Assume that signal CAF 710 have been asynchronously set to ‘1’ at the beginning of the test clock cycle. It then waits until the first rising edge of the signal ST_LTE 630 arrives. At that moment, signal CAF 710 will become ‘0’ (since the data-input pin of the flip-flop 720 is tied to ‘0’) and stay ‘0’ throughout the entire leakage test cycle. The overall timing control sequence of a test wrapper in a leakage test cycle iterates through the following 3 events:

Event 1 (At the 1^{st} rising edge (740) of ST_LTE 630): The voltage at node Y 370 will be sampled into the flip-flop 720. This is a false yet harmless sampling. The sampled value is not relevant and will be overwritten later by the 2^{nd} sampling;

Event 2 (At the falling edge (750) of CAF 710): The pre-charged TSV 310 is left floating from this moment on until the end of the test cycle; and

Event 3 (At the 2^{nd} rising edge (760) of ST_LTE 630): The voltage at node Y 370 will be sampled into the flip-flop 720 again. This is the real sampling for the leakage test.

There is a time delay between the first rising edge 740 of ST_LTE 630 and the falling edge 750 of CAF 710, due to the setup time of the flip-flop 720 and the delay of the AND gate 730. This combined delay, denoted as γ-delay, diminishes the original wait time. Fortunately, it is a constant term and can be pre-compensated during the wait time generation by the following process:

At wait-time generation:

Generated Wait-time=(Desired wait-time)+(γ-delay)

Actual wait-time as applied to each TSV:

$$\begin{matrix}Actual wait \text{-} time = ( Generated wait \text{-} time ) - ( γ \text{-} delay ) \\ = ( Desired wait \text{-} time ) + ( γ \text{-} delay ) - ( γ \text{-} delay ) \\ = ( Desired wait \text{-} time )\end{matrix}$$

If the substrate surrounding a TSV under test is biased at the supply voltage, instead of the ground voltage, logic ‘0’ signal, instead of logic ‘1’, needs to supplied to the input of the test-mode tri-state buffer 330. Also, the final ‘Pass/Fail’ result needs to be interpreted differently. For example, if at the final sampling time, the node Y 370 remains relatively low as its original discharged value, a sampled value of “0” indicates a “Pass”. On the other hand, it indicates a “Fail”.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1-10. (canceled)

11. A method, comprising:
applying logic “1” or “0” to one end of an interconnect during a first pulse; and
capturing, triggered by an edge of a second pulse, logic value at the one end, the first pulse preceding the second pulse by a time period, the time period being selected from a plurality of delay periods, the plurality of delay periods being generated by a logic device shared by a plurality of interconnects.

12. The method recited in claim 11, wherein the interconnect is a through-silicon via (TSV).

13. The method recited in claim 11, wherein the applying is performed using a tri-state buffer.

14. The method recited in claim 11, wherein the capturing is performed using a flip-flop.

15. The method recited in claim 11, wherein the first pulse and the second pulse are derived from two consecutive pulses of a signal.

16. The method recited in claim 15, wherein the first pulse is generated by a flip flop and a gating device based on an early pulse of the two consecutive pulses and the second pulse directly uses a late pulse of the two consecutive pulses.

17. An integrated circuit, comprising:
a first device configurable to apply logic “1” or “0” to one end of an interconnect during a first pulse;
a second device configurable to capture, triggered by an edge of a second pulse, logic value at the one end, the first pulse preceding the second pulse by a time period, the time period being selected from a plurality of delay periods; and
a third device, shared by a plurality of interconnects, configurable to generate the plurality of delay periods.

18. The integrated circuit recited in claim 17, wherein the interconnect is a through-silicon via (TSV).

19. The integrated circuit recited in claim 17, wherein the first device is a tri-state buffer.

20. The integrated circuit recited in claim 17, wherein the second device is a flip-flop.

21. The integrated circuit recited in claim 17, wherein the first pulse and the second pulse are derived from two consecutive pulses of a signal.

22. The integrated circuit recited in claim 17, further comprising:
a fourth device configurable to generate a signal comprising two pulses, an early pulse of the two pulses being used to generate the first pulse, a late pulse of the two pulses being used as the second pulse.

23. One or more non-transitory processor-readable media storing processor-executable instructions for causing one or more processors to create test circuitry in a design of an integrated circuit, the test circuitry comprising:
a first device configurable to apply logic “1” or “0” to one end of an interconnect during a first pulse;
a second device configurable to capture, triggered by an edge of a second pulse, logic value at the one end, the first pulse preceding the second pulse by a time period, the time period being selected from a plurality of delay periods; and
a third device, shared by a plurality of interconnects, configurable to generate the plurality of delay periods.

24. The one or more non-transitory processor-readable media recited in claim 23, wherein the interconnect is a through-silicon via (TSV).

25. The one or more non-transitory processor-readable media recited in claim 23, wherein the first device is a tri-state buffer.

26. The one or more non-transitory processor-readable media recited in claim 23, wherein the second device is a flip-flop.

27. The one or more non-transitory processor-readable media recited in claim 23, wherein the first pulse and the second pulse are derived from two consecutive pulses of a signal.

28. The one or more non-transitory processor-readable media recited in claim 23, wherein the test circuitry further comprises:
a fourth device configurable to generate a signal comprising two pulses, an early pulse of the two pulses being used to generate the first pulse, a late pulse of the two pulses being used as the second pulse.
